(19) United States
(12) Patent Application Publication
(10) Pub. No.: US 2010/0134486 A1
(43) Pub. Date: Jun. 3, 2010

(54) Automated Display and Manipulation of Photos and Video Within Geographic Software

(76) Inventor: David J. Colleen, (US)

Correspondence Address: David Colleen;c/o Planet 9 Studios, Suite 407, 525 Brannan St, San Francisco, CA, 94107, US

(21) Appl. No.: 12/326,889

(22) Filed: Dec. 3, 2008

(51) Int. Cl. G06T 17/00

(52) U.S. Cl. 345/419

(57) ABSTRACT

A system and method to create geographically located data and metadata from photos, video and user input. In one form, a user with a cell phone/camera can create and share a depiction of a real world location in 3D along with tagging and annotation of elements within the scene to aid in search indexing and sharing. In another form, these processes are used to automate the large scale collection and tagging of real world locations and information in 3D.

### CROSS REFERENCE TO RELATED APPLICATIONS

This application claims the benefit of U.S. Provisional Patent Application No. 60/991,745, filed Dec. 2, 2007 by the present inventors.

### FEDERALLY SPONSORED RESEARCH

Not Applicable

### SEQUENCE LISTING OR PROGRAM

Not Applicable

### BACKGROUND OF THE INVENTION

1. Field of the Invention

This invention generally relates to creation of 3D computer models, specifically to an improved, automated approach using digital photos or video.

2. Prior Art

Creating 3D models of real world locations and objects has traditionally required the use of professional authoring tools such as 3D Studio Max, Maya or Soft Image. The production of these models required significant amounts of training and time on the part of the user. Subsequently, image based 3D authoring tools such as Canoma, PhotoModeler and ImageModeler sought to reduce training and authoring times through the use of digital images in the modeling process. These tools required that the user manually identify common points or edges spanning one or more images. This too, was time consuming and costly as it required manual input as well as user training. While digital image based, 3D modeling is well known, it remains beyond the reach of consumer users and does not lend itself to large scale use. In contrast, 3D tools using laser or radar range-finding techniques have minimized user input but instead require expensive hardware and extensive training to operate the hardware. We need an easier way, for people of average skills and training to create and share 3D models of real world places.

### SUMMARY OF THE INVENTION

The present invention relates to the creation of 3D computer models based on an automated, image based approach so that the resulting 3D models can be easily created, viewed and shared. In a preferred embodiment, models are generated and viewed using a cellular telephone equipped with a still or video camera 101 and a GPS or another location mechanism as part of a location module 108. In this approach the user can create a 3D scene, tag or annotate objects within the scene, register the scene to other existing scenes and share the resulting scene with other users via a network server. The server can further process this field collected data including improved user positioning, abstraction of select data, the addition of property based information and advertising placement.

Another embodiment uses a camera equipped personal navigation device without a network connection.

Another embodiment used a vehicle based collection system geared toward the large scale collection of city and geographic data.

The following drawings are not drawn to scale and illustrate only a few sample embodiments of the invention. Other embodiments are easily conceivable by persons of skill in the art.

### BRIEF DESCRIPTION OF THE DRAWINGS

FIG. 1 is a schematic diagram of the preferred embodiment.

FIG. 2 is a schematic diagram of a non-networked embodiment.

FIG. 3 is a schematic diagram of a vehicle based embodiment.

### DETAILED DESCRIPTION OF THE PREFERRED EMBODIMENTS

The present invention relates to the creation and viewing and of 3D scenes, and applications thereof. In the detailed description of the invention, references to various embodiments may include a particular feature or structure, but every embodiment may not necessarily include that feature or structure.

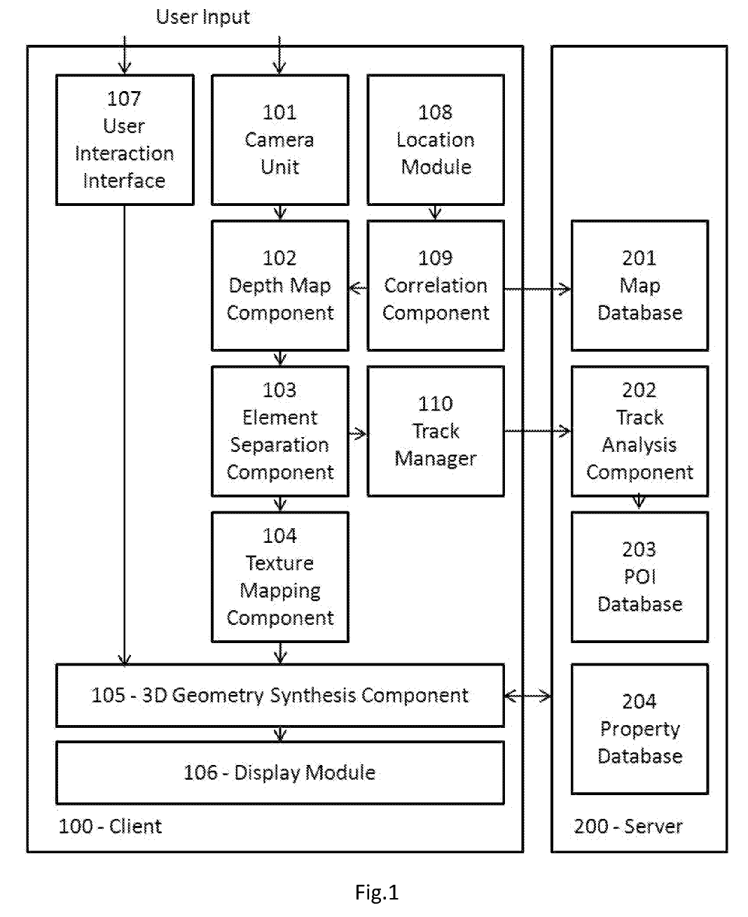

FIG. 1 shows a schematic diagram of a networked embodiment of our invention. A client 100 communicates with one or more servers 200, for example using the Internet or a local area network. The client 100 can be a general purpose cellular telephone equipped with a still or video camera. The server 200 can be a general purpose computer capable of receiving, processing and serving data to the client 100.

The user, operating the client 100, creates a series of photos or a video 101, the operation of which is further described herein.

As illustrated in FIG. 1, the resulting digital images or frames are transferred to the depth map component 102 which analyses the images, using known interferometric techniques to develop a spherical panorama based depth map describing the distances from the camera position to surrounding objects. In particular, the configuration used may be the one disclosed in U.S. Pat. No. 5,812,269, entitled “Triangulation-based 3-D imaging and processing method and system”.

The resulting depth map is then geo-located by the correlation component 109. The correlation component 109 tags depth map data with a geo-location derived from the location module 108. The resulting tagged data is also passed to the map database 201, the operation of which is further described herein.

The depth map is then passed to the element separation component 103, which detects and separates elements in the depth map into discreet elements based upon shape, location or movement. Techniques to detect and isolate shapes and movement are well known in the art. In particular, the configuration used may be the one disclosed in U.S. Pat. No. 6,449,384, entitled “Method and Apparatus for Rapidly Determining Whether a Digitized Image Frame Contains an Object of Interest”.

Elements discerned by the element separation component 103 to be in motion are tracked by the track manager 110, the operation of which is further described herein.

The resulting segmented depth map elements are used to generate a polygonal 3D model using approaches known in the art. Imagery, derived from the source photos or videos, is then extracted into texture maps and applied to the 3D polygonal geometry by the texture mapping component 104. One embodiment of this texture mapping component 104 is disclosed in U.S. Pat. No. 6,018,349, entitled “Patch-based alignment method and apparatus for construction of image mosaics”.

The resulting textured polygonal data is then passed to the 3D geometry synthesis component 105 which merges user annotation and tagging from the user interaction interface 107, the operation of which is further described herein and with data from the server 200, the operation of which is further described herein. In one embodiment, the tag or annotation would take the form of an XML file linked via a hyperlink to a 3D geometry node in an X3D file the description of which is well known in the art. In one embodiment, the 3D geometry synthesis component 105 uses parcel data from the property database 204 to further segment polygonal building data into individual building or building components. The 3D geometry synthesis component 105 delivers data to the display module 106, the operation of which is further described herein.

The user, operating the user interaction interface 107, adds text, audio or data tagging and or annotations to polygonal elements in the geometry synthesis component 105. In one embodiment, a user would be able to link geographic elements to sound, video, other data files or computer programs.

The location modules gives an initial geographic location to the correlation component 109 based on GPS, network triangulation, RFID, dead reckoning, IMU or other geographic location approaches. The correlation component may yield an improved geo-location based on comparing the depth map to existing 2D or 3D map data. The resulting geo-location is then passed to the map database 201, the operation of which is further described herein.

The track manager 110 maintains a unique ID number, position and orientation for each moving or POI element. The track manager 110 passes the element state information to the track analysis component 202, the operation of which is further described herein. In one implementation of the track manager 110, a user would have a control interface allowing the viewing of moving object over a specified time period.

Camera unit 101 refers to a digital still or video camera capable of creating a jpeg or other digital file format. This camera unit 101 may be part of a cell phone or other devise or conversely may be connected to the like via a Bluetooth or other network mechanism.

The server 200 refers to a network computer in communication with the client 100 via the Internet or other network connection. The server 200 includes one or more of the following components; map database 101, track analysis component 202, POI database 203, property database 204. The server 200 may include additional functions such as user administration, network administration and connection to other database servers.

The map database 201 stores all normal forms of 2D and 3D digital map data. It is able to deliver data to the geometry synthesis component 105 in a format suitable to the display device 106.

The track analysis component 202 merges moving elements received from track manager 110 with other elements already being tracked. In one embodiment, elements are replaced with proxy objects such as pre-built avatars, car models or icons. In another embodiment, the track analysis component 202 performs OCR procedures on POI elements to extract place name, street sign, business name or other text information for linking to the POI database 203 or for the addition of new POI elements to that database. These OCR techniques are well known in the art. In particular, the configuration used may be the one disclosed in U.S. Pat. No. 6,453,056, entitled “Method and Apparatus for Generating a Database of Road Sign Images and Positions”.

The POI database 203 stores POI data and passes this data to the 3D geometry synthesis component.

The property database 204 stores property specific data such as property line data, parcel size information, parcel numbers, occupant names and phone numbers and other data associated with specific parcels but not already housed in the map database 201 or the POI database 203.

The display module 106 is a display screen rendering data from the 3D graphics synthesis component making use of a graphics rendering library such as OpenGL ES. In one embodiment, the display module includes touch screen capabilities allowing the user interaction interface 107 to make use of user interactions via buttons, screen based keyboards, finger gestures or unit movement.

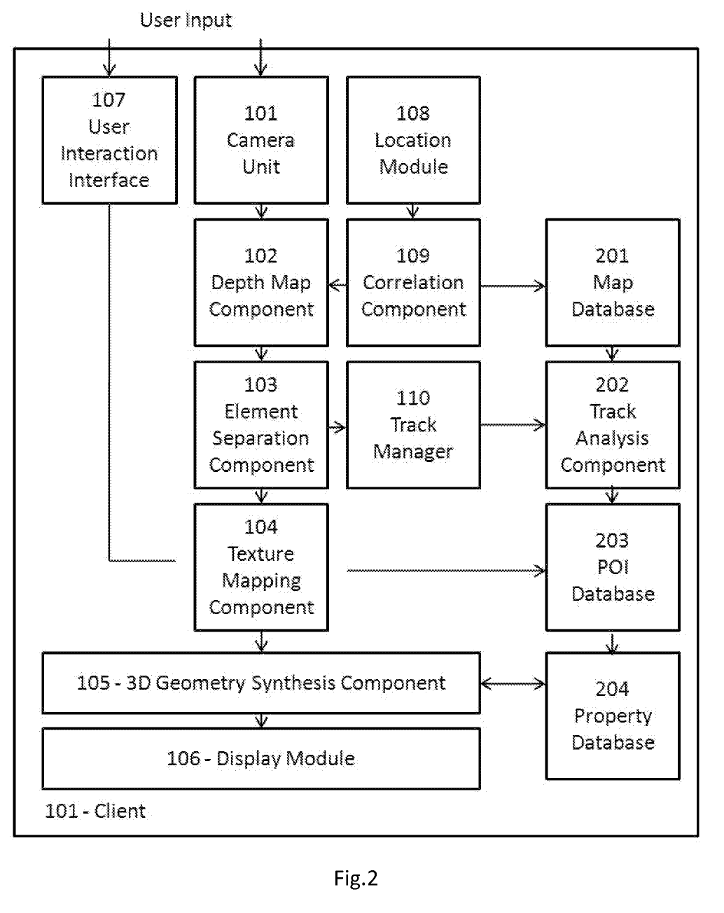

FIG. 2 shows a schematic diagram of a non-networked embodiment of our invention similar to that illustrated in FIG. 1 except that the server functions have been added to the client 101. One embodiment of client 101 would be a mobile navigation device, such as is made by Tom Tom, Garmin or Magellan,

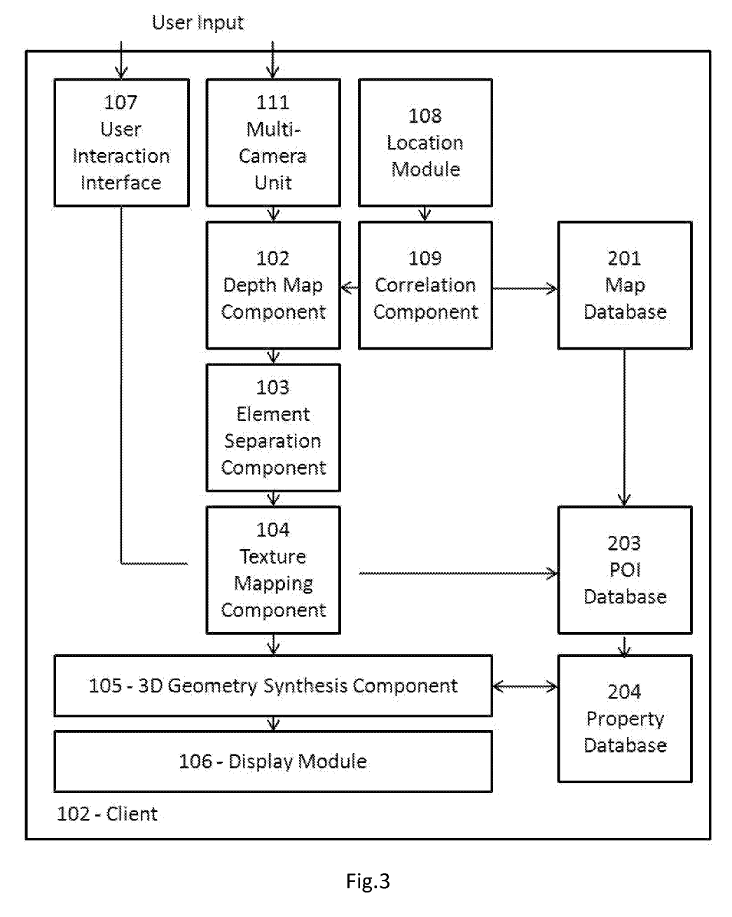

FIG. 3 shows a schematic diagram of an embodiment of our invention similar to that illustrated in FIG. 1 except that it is geared toward a vehicle based collection system for the large scale collection of city or terrain data. Client 102 omits the track manager 110 found in client 100 and replaces camera unit 101 with multi-camera unit 111, the operation of which is further described herein. Client 102 also omits the track analysis component 202.

The multi-camera unit 111 is comprised of two or more cameras affixed to a vehicle with the goal of capturing a wide field of view as a vehicle traverses a real world location. These cameras may be still, video or some combination thereof.

What is claimed as new and desired to be secured by Letters Patent of the United States is:

1. In a networked computer implemented method of authoring 3D models, wherein the model comprises a plurality of textured polygonal shapes, the method comprising the steps for each of said textured polygonal shapes, of:
a. Taking a digital photograph or video;
b. Storing the said digital photo or video;
c. Converting this data to a depth map;
d. Segmenting this depth map into individual elements;
e. Photo texturing the resulting individual elements;
f. Tagging and annotating the individual elements;
g. Geo-locating the individual elements;
h. Correlating the individual elements to a map database;
i. Tracking the location of moving individual elements;
j. Replacing at least one individual element with a pre-built element;
k. Using a property database to further segment individual elements;
l. To synthesize the resulting individual element into a unified 3D scene' and for the display of this scene on a computer display screen.

2. The method of claim 1, wherein the computer is non-networked.

3. The method of claim 1, wherein multiple cameras are used in a vehicle based configuration.
